(19) United States
(12) Patent Application Publication
(10) Pub. No.: US 2024/0404401 A1
(43) Pub. Date: Dec. 5, 2024

(54) TRAFFIC CONTROL METHOD AND APPARATUS, DEVICE, AND STORAGE MEDIUM

(71) Applicant: Tencent Technology (Shenzhen) Company Limited, Shenzhen (CN)

(72) Inventor: Siyang LIU, Shenzhen (CN)

(73) Assignee: Tencent Technology (Shenzhen) Company Limited, Shenzhen, GD (CN)

(21) Appl. No.: 18/802,654

(22) Filed: Aug. 13, 2024

Related U.S. Application Data
(63) Continuation of application No. PCT/CN2023/087457, filed on Apr. 11, 2023.

(30) Foreign Application Priority Data
Jun. 2, 2022 (CN) 202210621001.2

(51) Int. Cl. G08G 1/081; H04W 4/44

(52) U.S. Cl. CPC G08G 1/081; H04W 4/44

(57) ABSTRACT

Embodiments of this application disclose a traffic control method and apparatus, a device, and a storage medium, and relate to the field of computer technologies. The method includes: generating a first signal priority request packet, the first signal priority request packet including N signal priority requests; transmitting the first signal priority request packet; and receiving a first signal priority response packet returned for the first signal priority request packet, the first signal priority response packet including N signal priority responses for the N signal priority requests, and the N signal priority responses including information configured for indicating a first road traffic signal control machine of a first intersection to control a traffic management and control device of the first intersection.

### RELATED APPLICATION

This application is a continuation of International Patent Application No. PCT/CN2023/087457, filed Apr. 11, 2023, which claims priority to Chinese Patent Application No. 202210621001.2, filed with the China National Intellectual Property Administration on Jun. 2, 2022 and “TRAFFIC CONTROL METHOD AND APPARATUS, DEVICE, AND STORAGE MEDIUM”. The contents of International Patent Application No. PCT/CN2023/087457 and Chinese Patent Application No. 202210621001.2 are each incorporated herein by reference in their entirety.

### FIELD OF THE TECHNOLOGY

This application relates to the field of computer technologies, and in particular, to a traffic control technology.

### BACKGROUND OF THE DISCLOSURE

With the development of computer technologies and the increasing popularity of vehicles, a traffic condition on a road becomes more complex. Therefore, a traffic control method becomes more refined. For example, vehicles such as an ambulance vehicle, a police vehicle, and a fire vehicle may all need to respond to an emergency situation, and therefore need priority on the road. In addition, a public transport vehicle carrying passengers may also have priority over other vehicles on the road.

Therefore, a traffic control method that can flexibly control priorities of various types of vehicles is urgently needed.

### SUMMARY

Embodiments of this application provide a traffic control method and apparatus, a device, and a storage medium, which can flexibly control priority passage of a vehicle.

An embodiment of this application provides a traffic control method, performed by a first road side unit of a first intersection, the method including: generating a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection; transmitting the first signal priority request packet; and receiving a first signal priority response packet returned for the first signal priority request packet, the first signal priority response packet including N signal priority responses respectively for the N signal priority requests, and the N signal priority responses including information configured for indicating a first road traffic signal control machine of the first intersection to control a traffic management and control device of the first intersection.

An embodiment of this application provides a traffic control method, performed by a first road traffic signal control machine of a first intersection, the method including: receiving a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection; generating a first signal priority response packet based on the first signal priority request packet, the first signal priority response packet including N signal priority responses respectively for the N signal priority requests, and the N signal priority responses including information configured for indicating to control a traffic management and control device of the first intersection; and transmitting the first signal priority response packet.

An embodiment of this application provides a traffic control method, performed by a control platform, the method including: receiving a first signal priority request packet from a first road side unit of a first intersection, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection; transmitting the first signal priority request packet to a first road traffic signal control machine of the first intersection, the first signal priority request packet being configured for indicating the first road traffic signal control machine to generate a first signal priority response packet based on the first signal priority request packet, the first signal priority response packet including N signal priority responses respectively for the N signal priority requests, and the N signal priority responses including information configured for indicating to control a traffic management and control device of the first intersection; receiving the first signal priority response packet from the first road traffic signal control machine; and transmitting the first signal priority response packet to the first road side unit.

An embodiment of this application provides a traffic control apparatus, performed by a first road side unit of a first intersection, the apparatus including: a first generation module, configured to generate a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles in different entrance directions of the first intersection, or signal priority requests initiated by different types of vehicles at a same entrance of the first intersection, or signal priority requests initiated by a same type of vehicles at a same entrance of the first intersection; a transmitting module, configured to transmit the first signal priority request packet; and a receiving module, configured to receive a first signal priority response packet returned for the first signal priority request packet, the first signal priority response packet including N signal priority responses respectively for the N signal priority requests, and the N signal priority responses including information configured for indicating a first road traffic signal control machine of the first intersection to control a traffic management and control device of the first intersection.

An embodiment of this application provides a traffic control apparatus, performed by a first road traffic signal control machine of a first intersection, the apparatus including: a receiving module, configured to receive a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection; a second generation module, configured to generate a first signal priority response packet based on the first signal priority request packet, the first signal priority response packet including N signal priority responses respectively for the N signal priority requests, and the N signal priority responses including information configured for indicating to control a traffic management and control device of the first intersection; and a transmitting module, configured to transmit the first signal priority response packet.

An embodiment of this application provides a traffic control apparatus, performed by a control platform, the apparatus including: a receiving module, configured to receive a first signal priority request packet from a first road side unit of a first intersection, the first signal priority request packet including N signal priority requests, N being a positive integer greater than or equal to 1, and when N is greater than 1, the N signal priority requests corresponding to the N signal priority requests being configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection; a transmitting module, configured to transmit the first signal priority request packet to a first road traffic signal control machine of the first intersection, the first signal priority request packet being configured for indicating the first road traffic signal control machine to generate a first signal priority response packet based on the first signal priority request packet, the first signal priority response packet including N signal priority responses respectively for the N signal priority requests, and the N signal priority responses including information configured for indicating to control a traffic management and control device of the first intersection; a receiving module, further configured to receive the first signal priority response packet from the first road traffic signal control machine; and a transmitting module, further configured to transmit the first signal priority response packet to the first road side unit.

An embodiment of this application provides a computer device, including a processor, a memory, and an input/output interface; and the processor being connected to the memory and the input/output interface respectively, the input/output interface being configured to receive data and output data, the memory being configured to store a computer program, and the processor being configured to invoke the computer program, to enable the computer device including the processor to perform the traffic control method according to any embodiment of this application.

An embodiment of this application provides a computer-readable storage medium, having a computer program stored therein, the computer program being loaded and executed by a processor, to enable a computer device having the processor to perform the traffic control method according to any embodiment of this application.

An embodiment of this application provides a computer program product, including a computer program, the computer program being stored in a computer-readable storage medium. A processor of a computer device reads the computer program from the computer-readable storage medium, and the processor executes the computer program, so that the computer device performs the traffic control method provided in various optional implementations according to any embodiment of this application.

In the technical solutions provided in the embodiments of this application, each intersection has a corresponding road side unit. Using the first road side unit as an example, the first road side unit can first generate a first signal priority request packet, the first signal priority request packet includes N signal priority requests, where N is a positive integer greater than or equal to 1, and when N is greater than 1, the N signal priority requests are configured for indicating signal priority requests initiated by a same type of vehicles at different entrances of the first intersection, or signal priority requests initiated by different types of vehicles in different entrance directions of the first intersection, or signal priority requests initiated by different types of vehicles at a same entrance of the first intersection, or signal priority requests initiated by a same type of vehicles at a same entrance of the first intersection, thereby supporting control of various possible signal priority situations. Next, the first road side unit may transmit the first signal priority request packet, and a corresponding first road traffic signal control machine may receive the first signal priority request packet. In this way, the first road traffic signal control machine can respond to the first signal priority request and generate the first signal priority response packet. The first signal priority response packet includes N signal priority responses respectively for the N signal priority requests, and the N signal priority responses include information configured for indicating a first road traffic signal control machine of the first intersection to control a traffic management and control device of the first intersection, so that the priority passage of the vehicle can be controlled based on the N signal priority responses. The road traffic signal control machine at each intersection can respond to the received signal priority request to control the priority passage of the vehicle at the intersection, thereby achieving the objective of flexibly controlling the priority passage of the vehicle.

### BRIEF DESCRIPTION OF THE DRAWINGS

FIG. 1 is a diagram of a system architecture of a traffic control method according to an embodiment of this application.

FIG. 2 is a diagram of a system architecture of another traffic control method according to an embodiment of this application.

FIG. 3 is a flowchart of a traffic control method according to an embodiment of this application.

FIG. 4 is a schematic diagram of a first intersection according to an embodiment of this application.

FIG. 5 is a schematic diagram of a structure of an information frame according to an embodiment of this application.

FIG. 6 is a schematic diagram of a structure of a data sheet according to an embodiment of this application.

FIG. 7 is a flowchart of another traffic control method according to an embodiment of this application.

FIG. 8 is an architectural diagram of traffic control according to an embodiment of this application.

FIG. 9 is an architectural diagram of another traffic control according to an embodiment of this application.

FIG. 10 is a schematic diagram of a traffic control apparatus according to an embodiment of this application.

FIG. 11 is a schematic diagram of another traffic control apparatus according to an embodiment of this application.

FIG. 12 is a schematic diagram of another traffic control apparatus according to an embodiment of this application.

FIG. 13 is a schematic diagram of a structure of a computer device according to an embodiment of this application.

### DESCRIPTION OF EMBODIMENTS

The technical solutions in embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

In addition, the accompanying drawings are merely exemplary illustrations of this application and are not necessarily drawn to scale. The same reference numbers in the accompanying drawings represent the same or similar parts, and therefore, repeated descriptions thereof are omitted. Some of the block diagrams shown in the accompanying drawings are functional entities and do not necessarily correspond to physically or logically independent entities. The functional entities may be implemented in the form of software, or implemented in one or more hardware modules or integrated circuits, or implemented in different networks and/or processor apparatuses and/or micro-controller apparatuses.

Before the embodiments of this application are further described in detail, nouns and terms involved in the embodiments of this application are described. The nouns and terms provided in the embodiments of this application are applicable to the following explanations.

An intelligent vehicle infrastructure cooperative system (e.g., an Intelligent Vehicle Infrastructure Cooperative System, IVICS), vehicle infrastructure cooperative system for short, is a development direction of an intelligent traffic system (Intelligent Traffic System, ITS). The vehicle infrastructure cooperative system adopts advanced wireless communication and new-generation Internet technologies to comprehensively implement dynamic real-time information interaction of vehicle-to-vehicle, and vehicle-to-road, and perform active vehicle safety control and road collaboration management based on acquisition and integration of full-time dynamic traffic information, thus fully implementing effective collaboration of people, vehicles and roads, ensuring traffic safety and improving traffic efficiency, thereby forming a safe, efficient, and environmentally friendly road traffic system.

Intersection: Since a road network is distributed in a mesh structure, there are a plurality of intersecting intersections. These intersections, that is places at which a plurality of roads intersect, may also be referred to as connecting points of the roads. The connecting points are the intersections. The intersections, also referred to as intersections in road engineering, are intersections at which the plurality of roads (such as two or more roads) intersect. The intersections may be of different types, such as a crossroad, a T-intersection, and a Y-intersection. The crossroad is an intersection at which two roads intersect in a “cross” shape, and the T-intersection is an intersection at which two roads intersect in a T shape.

Lane: Lane refers to a roadway at which a vehicle travels on a forked road, also referred to as a traffic lane. Generally, lanes on roads are divided by using a solid line or a curve. Lanes near intersections are generally divided into lanes with different driving directions through the intersections, such as a left-turn lane, a straight lane, a right-turn lane, a U-turn lane, and the like, or lanes with combined directions, such as a left-turn and straight lane, a straight and right-turn lane, a left-turn and U-turn lane, and the like.

Phase of a signal light: Because intersections connect different roads and provide a place for a vehicle to switch to other roads, the intersections are prone to traffic chaos. To coordinate traffic at the intersections, signal lights (or road traffic lights) are usually installed at the intersections to control vehicle movement. For example, four sets of signal lights are generally disposed at a crossroad (one for each fork in the road), and a combination of states of each signal light at the crossroad is referred to as a phase. A standard crossroad has twelve vehicle movement modes, namely going straight (east-west, west-cast, south-north, and north-south), turning slightly (cast-north, west-south, north-west, and south-east), and large turns (cast-south, west-north, north-cast, and south-west), and a signal light on the fork may control the movement of the vehicle on the fork. The foregoing twelve movement modes may be combined with each other to form a phase. For example, an east-west straight phase includes two movement modes: east-west and west-cast. The movement mode of the vehicle at the entire intersection may be controlled by a signal light phase, so that a working state of the signal light at the intersection may also be represented as the signal light phase.

In an embodiment of this application, FIG. 1 is a diagram of a system architecture of a traffic control method according to an embodiment of this application. As shown in FIG. 1, the system architecture of the traffic control method may include: a first road side unit 110 and a first road traffic signal control machine 120.

The first road side unit 110 may generate a first signal priority request packet through the traffic control method provided in this embodiment of this application. In addition, the first road side unit 110 may transmit the first signal priority request packet to the first road traffic signal control machine 120. The first road traffic signal control machine 120 may respond to the first signal priority request packet and generate a corresponding first signal priority response packet. The first road traffic signal control machine 120 may further return the first signal priority response packet to the first road side unit 110.

For example, the first road side unit 110 and the first road traffic signal control machine 120 may be connected via a network, and the network may be a wireless network or a wired network. In a possible implementation, the first road side unit 110 may be disposed on a road side of a first intersection and configured to monitor a vehicle passing through the first intersection. Aa model of the first road side unit 110 is not limited in this embodiment of this application. The first road traffic signal control machine 120 may be disposed at the first intersection, and may be configured to control a traffic management and control device at at least one entrance of the first intersection. A model of the first road traffic signal control machine 120 is not limited in this embodiment of this application.

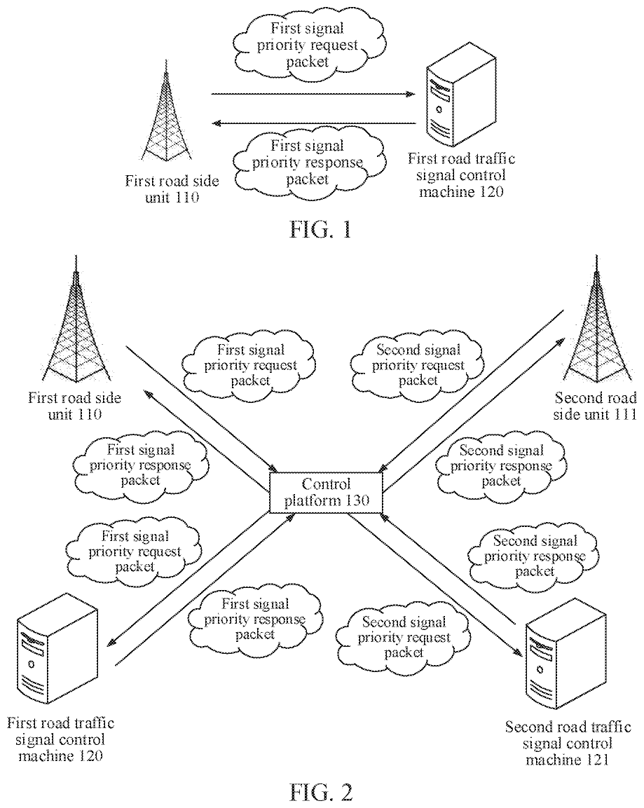

Alternatively, as shown in FIG. 2, the system architecture of the traffic control method may further include: a control platform 130. The control platform 130 may connect one to more than one road side units and one to more than one road traffic signal control machines. For example, the control platform 130 may be connected to one or more road side units and one or more road traffic signal control machines respectively via a network, and the network may be a wireless network or a wired network.

For example, the control platform 130 may connect the first road side unit 110 of the first intersection and a second road side unit 111 of a second intersection, and may connect the first road traffic signal control machine 120 of the first intersection and a second road traffic signal control machine 121 of the second intersection. The first road side unit 110 may generate the first signal priority request packet through the traffic control method provided in this embodiment of this application, and may transmit the first signal priority request packet to the control platform 130. In addition, the second road side unit 111 may generate a second signal priority request packet through the traffic control method provided in this embodiment of this application, and may transmit the second signal priority request packet to the control platform 130. The control platform 130 may receive the foregoing first signal priority request packet and second signal priority request packet respectively, and may transmit the first signal priority request packet to the first road traffic signal control machine 120 and/or the second road traffic signal control machine 121 based on content in the first signal priority request packet. The control platform 130 may also transmit the second signal priority request packet to the first road traffic signal control machine 120 and/or the second road traffic signal control machine 121 based on content in the second signal priority request packet.

For example, the control platform 130 may be a computer device that can connect one to more road side units and one to more road traffic signal control machines, such as a server or a terminal as examples. When the control platform 130 is a server, in a possible implementation, the server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middle ware service, a domain name service, a security service, a CDN (Content Delivery Network, content delivery network), big data and an artificial intelligence platform, and the like. When the control platform 130 is a terminal, in a possible implementation, the terminal may be a mobile phone, a vehicle-mounted terminal, a computer, or an intelligent voice interaction device, as non-limiting examples.

In a possible implementation, a standard communication technology and/or protocol is used for the wireless network or the wired network. The network is usually the Internet, but may alternatively be any other network, including but not limited to, a local area network (Local Area Network, LAN), a metropolitan area network (Metropolitan Area Network, MAN), a wide area network (Wide Area Network, WAN), or any combination of a mobile, wired, or wireless network, a dedicated network, or a virtual dedicated network. In some embodiments, technologies and/or formats, such as hypertext markup language (Hyper Text Mark-up Language, HTML) and extensible markup language (Extensible Markup Language, XML), are used for representing data exchanged through a network. In addition, all or some links may be encrypted by using conventional encryption technologies such as a secure socket layer (Secure Socket Layer, SSL), transport layer security (Transport Layer Security, TLS), a virtual private network (Virtual Private Network, VPN), and internet protocol security (Internet Protocol Security, IPsec). In some other embodiments, custom and/or dedicated data communication technologies may also be used in place of or in addition to the foregoing data communication technologies.

Quantities of first road side units 110 and first road traffic signal control machines 120 in FIG. 1, and quantities of first road side units 110, second road side units 111, first road traffic signal control machines 120, second road traffic signal control machines 121, and control platforms 130 in FIG. 2 are all illustrative. There may be any quantity of first road side units 110, second road side units 111, first road traffic signal control machines 120, second road traffic signal control machines 121, and control platforms 130 based on actual requirements. The quantities are not limited in the embodiments of this application.

This exemplary implementation is described in detail below with reference to the drawings and embodiments.

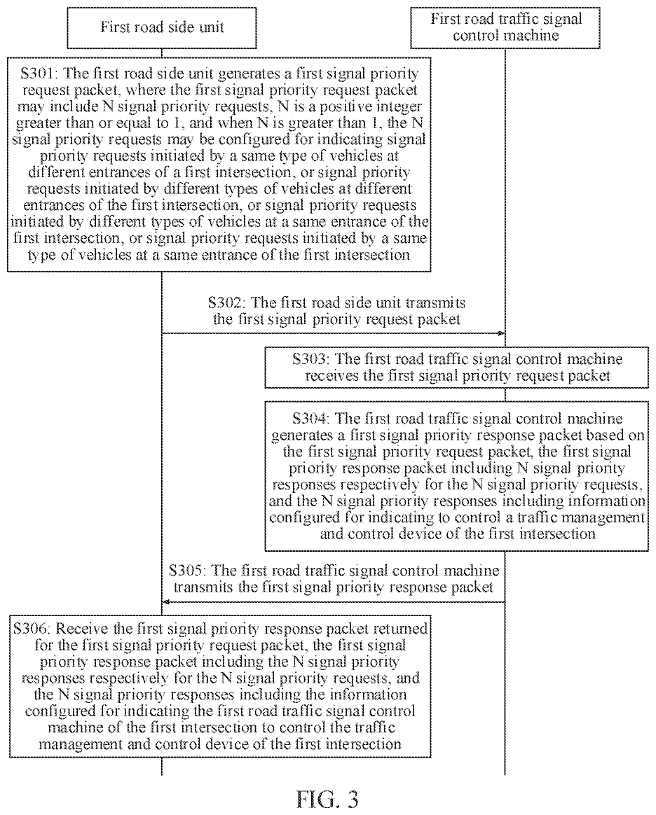

First, this embodiment of this application provides a traffic control method. The method may be applied to interaction between the first road side unit of the first intersection and the first road traffic signal control machine of the first intersection, or the method may be applied to interaction between the first road side unit of the first intersection, the first road traffic signal control machine of the first intersection, and the control platform. FIG. 3 is a flowchart of a traffic control method according to an embodiment of this application. In this embodiment of this application, an example in which this method is applied to the intersection between the first road side unit of the first intersection and the first road traffic signal control machine of the first intersection is used. The foregoing first road side unit, the first road traffic signal control machine, and the control platform may all be included in an intelligent vehicle infrastructure cooperative system.

As shown in FIG. 3, the traffic control method provided in this embodiment of this application may include the following S301 to S308.

S301: The first road side unit generates a first signal priority request packet, where the first signal priority request packet may include N signal priority requests, N is a positive integer greater than or equal to 1, and when N is greater than 1, the N signal priority requests may be configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection. For example, a position of the first road side unit at the first intersection is not limited in this embodiment of this application, provided that the first road side unit is located at a position at which a vehicle that is to enter the first intersection can be detected. A quantity and types of vehicles that initiate a signal priority request is also not limited in this embodiment of this application. For example, the quantity of vehicles that initiate the signal priority request may be determined based on an application scenario. The types of vehicles that initiate the signal priority request may include a public transport vehicle, an ambulance vehicle, a fire vehicle, a police vehicle, and the like.

The signal priority request may be a request initiated to perform priority control based on a traffic signal. The priority control performed based on the traffic signal may be, for example, providing a signal for priority passage through a signal light to a vehicle requesting priority passage. The signal priority request packet may be a data packet generated by the road side unit based on the N priority requests. To distinguish signal priority request packets generated by different road side units, a signal priority request packet generated by the first road side unit may be referred to as the first signal priority request packet, that is, the first signal priority request packet is a signal priority request packet generated by the first road side unit. By analogy, a signal priority request packet generated by the second road side unit may be referred to as the second signal priority request packet, and the like.

When N is greater than 1, the same type of vehicles mentioned above may be understood as that a plurality of signal priority requests involve the same type of vehicles. For example, the types of vehicles that initiate the signal priority request may be a public transport vehicle, an ambulance vehicle, a fire vehicle, a police vehicle, and the like, and in this case, the obtained N signal priority requests are all initiated by the public transport vehicle.

When N is greater than 1, the different types of vehicles mentioned above may be understood as that the types of vehicles that initiate the signal priority request are different. Specifically, all signal priority requests of the plurality of signal priority requests are initiated by different types of vehicle, or at least two signal priority requests of the plurality of signal priority requests are initiated by different types of vehicles. For example, in three signal priority requests, two signal priority requests are initiated by public transport vehicles, and one signal priority request is initiated by a fire vehicle. Alternatively, the three signal priority requests are initiated by a public transport vehicle, an ambulance vehicle, and a fire vehicle respectively.

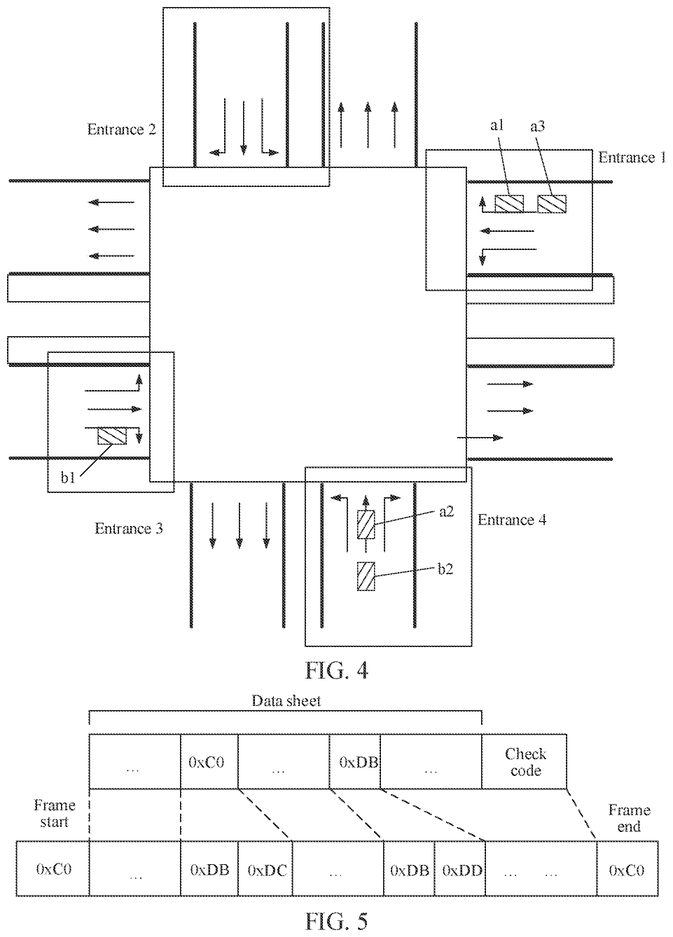

In an exemplary embodiment, the first intersection may be of different types. For example, the first intersection may be a crossroad, a T-intersection, or a Y-intersection. An example in which the first intersection may be a crossroad is used. As shown in FIG. 4, the first intersection includes four entrances, namely, an entrance 1, an entrance 2, an entrance 3, and an entrance 4.

For example, in FIGS. 4, a1, a2, and a3 are all public transport vehicles, and b1 and b2 are all ambulance vehicles. For example, a1 is to be driven into the first intersection from the entrance 1 of the first intersection, and a2 is to be driven into the first intersection from the entrance 4 of the first intersection. When a1 and a2 respectively transmit a signal priority request to the first road side unit, a first signal priority request packet generated by the first road side unit may include two signal priority requests, and the two signal priority requests may be configured for indicating signal priority requests initiated by a same type of vehicles at different entrances of the first intersection.

For another example, a1 is to be driven into the first intersection from the entrance 1 of the first intersection, and b1 is to be driven into the first intersection from the entrance 3 of the first intersection. When a1 and b1 respectively transmit a signal priority request to the first road side unit, a first signal priority request packet generated by the first road side unit may include two signal priority requests, and the two signal priority requests may be configured for indicating signal priority requests initiated by different types of vehicles at different entrances of the first intersection.

For another example, a2 is to be driven into the first intersection from the entrance 4 of the first intersection, and b2 is to be driven into the first intersection from the entrance 4 of the first intersection. When a2 and b2 respectively transmit a signal priority request to the first road side unit, a first signal priority request packet generated by the first road side unit may include two signal priority requests, and the two signal priority requests may be configured for indicating signal priority requests initiated by different types of vehicles at a same entrance of the first intersection.

For another example, both a1 and a3 are to enter the first intersection from the entrance 1. When a3 and a1 respectively transmit a signal priority request to the first road side unit, a first signal priority request packet generated by the first road side unit includes two signal priority requests, and the two signal priority requests are configured for indicating signal priority requests initiated by a same type of vehicles at a same entrance of the first intersection.

The method of generating the first signal priority request packet is not limited in the embodiments of this application. For example, a vehicle that is to enter the first intersection may transmit a signal priority request to the first road side unit. Therefore, the traffic control method provided in the embodiments of this application may further include: receiving a signal priority request transmitted by at least one vehicle. The signal priority request is configured for requesting priority passage. Correspondingly, the method of generating the first signal priority request packet may include determining the first signal priority request packet based on the signal priority request transmitted by at least one vehicle. Alternatively, the traffic control method provided in the embodiments of this application may further include that the first road side unit monitors a vehicle that is to enter the first intersection, determines a monitoring result, and then generates the first signal priority request packet based on the monitoring result.

In some embodiments, each signal priority request includes entrance information and request priority manner information at the first intersection.

For example, the entrance information of the first intersection is configured for indicating a road entrance at which a request is preferential. In a possible implementation, the entrance information of the first intersection may be represented by an integer from 0 to 359, which is a clockwise rotation angle starting from the geographical north direction, and a unit is a degree) (°). The value 0 represents 0 degrees to 1 degree, including 0 degrees and excluding 1 degree. By analogy, the value 359 represents 359 degrees to 360 degrees, including 359 degrees and excluding 360 degrees. For example, the request priority manner information is configured for indicating a manner of priority passage, which may include, for example, straight ahead priority, left turn priority, right turn priority, and U-turn priority.

Content in the signal priority request is stipulated in the embodiments of this application. The signal priority request is limited to including the entrance information and the request priority manner information, so that traffic control may be performed on a vehicle at a specific entrance in the priority passing manner indicated by the request priority manner information, and convenience and accuracy of traffic control is ensured.

In some embodiments, to perform traffic control on vehicles more flexibly and conveniently, each signal priority request further includes at least one of request priority level information, request priority duration information, vehicle type information, vehicle location information, information about a distance between a vehicle and the first intersection, information about estimated arrival time at which a vehicle arrives at the first intersection, and information about a quantity of passengers on a vehicle. The content in the signal priority request is stipulated in the embodiments of this application, thereby enriching the content in the signal priority request, and making traffic control on the vehicle more flexible and convenient.

For example, the request priority level information is configured for indicating a priority level of the corresponding signal priority request. The priority level may be divided in different manners, for example, may be divided into levels such as low, medium, and high. For example, a priority level indicated by request priority level information corresponding to a signal priority request transmitted by an ambulance vehicle carrying a critically ill patient may be high. A priority level indicated by request priority level information corresponding to a signal priority request transmitted by a police vehicle may be medium. A priority level indicated by request priority level information corresponding to a signal priority request transmitted by a public transport vehicle may be low. For example, the request priority duration information is configured for indicating a duration corresponding to the signal priority request. For example, a signal priority request transmitted by a police vehicle to the first road side unit may be requesting straight ahead priority after 10 seconds. Therefore, the request priority duration information is 10 seconds. For example, the vehicle type information is configured for indicating a type of a vehicle that can initiate the signal priority request. For example, the type of the vehicle may include a public transport vehicle, an ambulance vehicle, a fire vehicle, and a police vehicle.

For example, the vehicle location information may be configured for indicating a location of a vehicle. The location information may be represented in various forms, such as spatial coordinates or a longitude and a latitude. When the location information is represented by a longitude and a latitude, the location information may include longitude information and latitude information. For example, longitude information of a vehicle may be represented by single-precision floating-point data ranging from −180 to 180, while the latitude information of the vehicle may be represented by single-precision floating-point data ranging from −90 to 90. The information about a distance between a vehicle and the first intersection may be configured for indicating the distance between the vehicle to the intersection. For example, the information about the distance between the vehicle and the first intersection may be represented by a number ranging from 0 to 255, and a unit may be 5 meters. For example, the information about the estimated arrival time at which a vehicle arrives at the first intersection is configured for indicating the estimated time of the vehicle arriving at the first intersection. The information about the estimated arrival time at which a vehicle arrives at the first intersection may be obtained through monitoring by the first road side unit, or may be carried in the signal priority request transmitted by the vehicle to the first road side unit. In some embodiments, the information about the estimated arrival time at which a vehicle arrives at the first intersection may be represented by a number ranging from 0 to 255, and a unit may be a second. For example, when the vehicle is a public transport vehicle, the first signal priority request packet may also include information about a quantity of passengers on the vehicle. For example, the information about a quantity of passengers on the vehicle may be represented by a number ranging from 0 to 255.

In an exemplary embodiment, information included in a possible signal priority request may be as shown in Table 1. The signal priority request may include ten types of information in total: entrance information, request priority manner information, request priority level information, request priority duration information, vehicle type information, longitude information, latitude information, information about a distance between a vehicle and an intersection, information about estimated arrival time, and passenger quantity information. An example in which the vehicle is a public transport vehicle is used in the following Table 1, to describe formats and content of the signal priority request by using an example. An intersection in Table 1 may include the first intersection. For the values of the foregoing ten types of information and related descriptions thereof, refer to the foregoing embodiments, and details are not described herein again. For example, the signal priority request may be transmitted in a form of an information frame.

A quantity of bytes of the entrance information may be two. A quantity of bytes of the request priority manner information may be one, where 0x00 corresponds to none, 0x01 corresponds to straight ahead priority, 0x02 corresponds to left turn priority, 0x03 corresponds to right turn priority, and 0x04 corresponds to U-turn priority. Therefore, a value range may be 0 to 4. Values other than 0 to 4 are not limited in the embodiments of this application, and information indicated by other values may be retained temporarily. A quantity of bytes of the request priority level information may be one. 0x00 corresponds to none, 0x01 corresponds to low, 0x02 corresponds to medium, and 0x03 corresponds to high. Therefore, a value range may be 0 to 3. Values other than 0 to 3 are not limited in the embodiments of this application, and information indicated by other values may be retained temporarily.

For example, a quantity of bytes of the request priority duration information may be one, and the value may be from 0 to 255, and a unit is a second. A quantity of bytes of the vehicle type information may be one. 0x00 corresponds to none, 0x01 corresponds to a public transport vehicle, 0x02 corresponds to an ambulance vehicle, 0x03 corresponds to a fire vehicle, and 0x04 corresponds to a police vehicle. Therefore, a value range may be 0 to 4. Values other than 0 to 4 are not limited in the embodiments of this application, and information indicated by other values may be retained temporarily.

A quantity of bytes of the longitude information may be four. A quantity of bytes of the latitude information may be four. A quantity of bytes of the information about a distance between a vehicle and an intersection may be one. A quantity of bytes of the information about the estimated arrival time may be one. A quantity of bytes of the passenger quantity information may be one. For example, the greater the quantity of passengers, the higher the request priority level corresponding to the vehicle may be.

TABLE 1

| Num- | | Number | | |
|---|---|---|---|---|
| ber | Name | of bytes | Value | Description |
| 1 | Entrance | 2 | 0 | Road entrance at which a |
| | information: | | | request is preferential. |
| | | | | An integer, which is a |
| | | | | clockwise rotation angle |
| | | | | starts from the geographical |
| | | | | north direction, and a |
| | | | | unit is a degree (°). The |
| | | | | value 0 represents 0 |
| | | | | degrees to 1 degree, |
| | | | | including 0 degrees and |
| | | | | excluding 1 degree, |
| | | | | the same below |
| 2 | Request priority | 1 | 0 to 4 | 0x00 none |
| | manner | | | 0x01 straight ahead priority |
| | information | | | 0x02 left turn priority |
| | | | | 0x03 right turn priority |
| | | | | 0x04 U-turn priority |
| | | | | Others reserved |
| 3 | Request | 1 | 0 to 3 | 0x00 none |
| | priority | | | 0x01 low |
| | level | | | 0x02 medium |
| | information | | | 0x03 high |
| | | | | Others reserved |
| 4 | Request priority | 1 | 0 to 255 | A duration of the |
| | duration | | | request signal priority, |
| | information | | | where a unit is a second |
| 5 | Type | 1 | | 0x00 none |
| | information | | | 0x01 public transport vehicle |
| | | | | 0x02 ambulance vehicle |
| | | | | 0x03 fire vehicle |
| | | | | 0x04 police vehicle |
| | | | | Others reserved |
| 6 | Longitude | 4 | −180 to | Single-precision |
| | information | | 180 | floating-point data, a |
| | | | | longitude of a requesting |
| | | | | vehicle location |
| 7 | Latitude | 4 | −90 to | Single-precision |
| | information | | 90 | floating-point data, a |
| | | | | latitude of a requesting |
| | | | | vehicle location |
| 8 | Distance | 1 | 0 to 255 | A distance between |
| | information | | | a vehicle and an |
| | from | | | intersection, where |
| | intersection | | | a unit is 5 meters |
| 9 | Information | 1 | 0 to 255 | Estimated time for a |
| | about | | | vehicle to arrive at an |
| | estimated | | | intersection, where a |
| | arrival time | | | unit is a second |
| 10 | Passenger | 1 | 0 to 255 | A quantity of passengers |
| | quantity | | | on the vehicle, |
| | information | | | mainly used for a public |
| | | | | transport vehicle |

In some embodiments, the first signal priority request packet may further include operation type information of the signal priority request. For example, the first signal priority request may be transmitted in a form of an information frame. The information frame may include the operation type information. The operation type information may include operation types such as querying a request, setting a request, setting a response, and the like, and each operation type may be represented by one encoding. For example, the operation type of the signal priority request may belong to setting a request, and the encoding of the operation type information of the first signal priority request may be 0x81 (hexadecimal).

In some embodiments, the first signal priority request packet further includes an object identifier of the first signal priority request packet, and the object identifier may instruct the first signal priority request packet to be configured for describing the signal priority request reported by the vehicle. For example, the object identifier may include classification of the object identifier and a name of the object identifier. For example, the object identifier of the first signal priority request packet may be classified as signal priority, and a corresponding code may be set to 06. The name of the object identifier of the first signal priority request packet may be signal priority request, and the corresponding code may be set to 01. Therefore, a hexadecimal value of the object identifier corresponding to the first signal priority request packet is 0x0601.

In this embodiment of this application, since the first signal priority request packet includes the object identifier, based on the object identifier, the first signal priority request packet may be identified and configured for describing the signal priority request reported by the vehicle, so that the first signal priority request packet may be identified and responded to in a timely and accurate manner to perform traffic control on the vehicle.

In some embodiments, the first signal priority request packet further includes information about a request packet length and/or signal priority request quantity information of the first signal priority request packet. For example, the information about the request packet length of the first signal priority request packet is configured for indicating a total quantity of bytes of messages of the N signal priority requests included in the first signal priority request packet. The request packet length may be represented by an integer ranging from 1 to 65535. The quantity of bytes of the request packet length may be 2.

The signal priority request quantity information of the first signal priority request packet is configured for indicating a quantity of signal priority requests included in the first signal priority request packet transmitted by the first road side unit. The request packet length may be represented by an integer ranging from 1 to 20. The quantity of bytes of the request packet length may be 1. In some embodiments, after the first road side unit obtains the signal priority requests of a plurality of vehicles, the same signal priority requests among the signal priority requests of the plurality of vehicles may be merged. For example, as shown in FIG. 4, a1, a2, a3, b1, and b2 all transmit the signal priority request to the first road side unit, and then the first road side unit obtains a total of 5 signal priority requests. When a2 and b2 in FIG. 4 both request priority to go straight at the entrance 4, and a distance difference between a2 and b2 and the first intersection is less than a preset distance threshold, the signal priority requests of a2 and b2 may be considered to be the same signal prioritize requests and the signal priority requests may be merged. Therefore, the signal priority request quantity information of the first signal priority request packet is 4. The value of the preset distance threshold is not limited in the embodiments of this application, and the preset distance threshold may be set based on experience or application scenarios.

The embodiments of this application stipulate the content in the signal priority request, thereby enriching the content in the signal priority request. In addition, whether the first signal priority request exceeds a processing limit of the control platform or the first road traffic signal control machine is verified based on the information about the request packet length, to ensure normal traffic control. In fact, each signal priority request corresponds to a signal priority response. The quantity of signal priority responses may be verified based on the signal priority request quantity information to avoid missing responses to the signal priority requests and ensure the flexibility and accuracy of traffic control for the vehicle.

The content of a possible signal priority request packet may be shown in Table 2. The content of the signal priority request packet in Table 2 may include a message length, a quantity of priority requests, and a priority request. The message length is configured for indicating the information about the request packet length, the priority request quantity is configured for indicating the signal priority request quantity information, and the priority request is configured for indicating the signal priority request. The message length and the quantity of priority requests may be determined as previously described, and as such are not described herein again. In addition, the priority request in Table 2 may include 1 to N signal priority requests. The information in each signal priority request may be included according to Table 1, as previously described.

TABLE 2

| | | Number of | | |
|---|---|---|---|---|
| Number | Name | bytes | Value | Description |
| 1 | Message | 2 | 1 to | Integer, a total |
| | length | | 65535 | quantity of bytes in the |
| | | | | message |
| 2 | Number of | 1 | 1 to 20 | Integer, a quantity |
| | priority | | | of transmitted signal |
| | requests | | | priority requests |
| 3 | Priority request | | | Including 1 to N |
| | | | | signal priority requests |

In some embodiments, the first signal priority request packet is based on a data sheet exchange manner of information frame encapsulation, and the first signal priority request packet includes a frame start, a first data sheet, a first check code, and a frame end; the first data sheet includes at least one of a first link code, a first transmitter identifier, a first receiver identifier, a first timestamp, first survival time, a first protocol version, operation type information of a signal priority request, the object identifier of the first signal priority request packet, a first signature tag, first reserved information, first message content, and a first signature certificate; and the first message content includes the N signal priority requests.

In an exemplary embodiment, a structure of an information frame may be shown in FIG. 5. The frame structure includes four parts: a frame start, a data sheet, a check code, and a frame end. Both the frame start and the frame end may be 1 byte, and the value may be 0xC0. A check code may be between the data sheet and the frame end, and the check code may be 2 bytes. For example, the check code may be generated through the CRC16 (Cyclic Redundancy Check 16) algorithm, and a check range of the generated check code may be all bytes of the data sheet. In addition, data escaping may be performed after the check is completed. When the value of a specific byte in the data sheet or check code is 0xC0, 0xDB or 0xDC may be used to perform escaping replacement. Additionally, when the value of a specific byte in the data sheet or check code is 0xDB, 0xDB or 0xDD may be used to perform escaping replacement.

Based on the structure of the information frame shown in FIG. 5, the data sheet in the first signal priority request packet is the foregoing first data sheet, and the check code in the first signal priority request packet is the foregoing first check code.

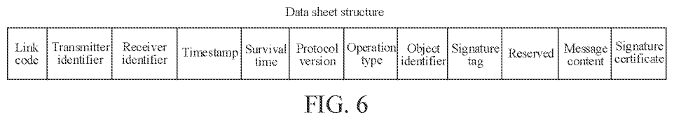

A structure of a possible data sheet may be shown in FIG. 6. The structure of the data sheet may include a link code, a transmitter identifier, a receiver identifier, a timestamp, survival time, a protocol version, an operation type, an object identifier, a signature tag, reservation, message content, and a signature certificate. For example, for the link code, the transmitter identifier, the receiver identifier, the timestamp, the survival time, the protocol version, the operation type, the signature tag, the reservation, the message content, and the signature certificate, refer to rules in GAT 1743-2020 (Road Traffic Signal Control Machine Information Release Interface Specification). The transmitter identifier and the receiver identifier may determine the unique identity of the transmitter and the receiver in the system. The operation types of the signal priority request and the signal priority response packet may respectively reuse the “setting a request 0x81” and “setting a response 0x84” defined by GAT 1743-2020.

According to FIG. 6, the first data sheet in the first signal priority request packet may correspondingly include a first link code, a first transmitter identifier, a first receiver identifier, a first timestamp, first survival time, a first protocol version, operation type information of a signal priority request, the object identifier of the first signal priority request packet, a first signature tag, first reserved information, first message content, and a first signature certificate. The first data sheet in the first signal priority request packet only needs to include at least one of the items. FIG. 6 is not configured for limiting a quantity of information items included in the first data sheet in the first signal priority request packet.

The object identifier in FIG. 6 adds “signal priority/06” to the object identifier defined in GAT 1743-2020, as shown in Table 3. In Table 3, classification of the object identifier may include a “signal control state”, a “dynamic traffic identifier”, a “signal control parameter”, a “traffic state”, “other information”, and a “signal priority”. The codes corresponding to the foregoing six categories may be 01, 02, 03, 04, 05, and 06 respectively. For the names/codes, values, and related descriptions corresponding to the “signal control state”, the “dynamic traffic identifier”, the “signal control parameter”, the “traffic state”, the “other information”, and the “signal priority”, refer to GAT 1743-2020, and details are not described herein again. In Table 3, the name corresponding to the “signal priority” may be signal priority request and response, and the corresponding code is 01. Therefore, both the signal priority request packet and the signal priority response packet may use the object identifier value of 0x0601. The object identifier in a specific information frame is 0x0601, which means that the information frame is configured for describing the signal priority request reported by the vehicle, the response of the road traffic signal control machine, and the like. The vehicles include the foregoing public transport vehicle, the ambulance vehicle, the fire vehicle, the police vehicle, and the like.

TABLE 3

| Object identifier | | | |
|---|---|---|---|
| Classification/ | | | |
| code | Name/code | Value | Explanation |
| Signal control | Signal machine | 0x0101 | Describe a current |
| state/01 | operating state/01 | | operating state of the |
| | | | signal machine. For |
| | | | example: a normal |
| | | | working state, a non- |
| | | | working state, a fault |
| | | | state, and the like |
| | Signal control | 0x0102 | Describe a current |
| | manner/02 | | control manner of the |
| | | | signal machine, such |
| | | | as: yellow flash |
| | | | control, multi-time |
| | | | control, manual control, |
| | | | induction control, |
| | | | cable-free coordinated |
| | | | control, single-point |
| | | | optimization control, |
| | | | bus signal priority, |
| | | | emergency event |
| | | | priority, and the like |
| | Signal light color | 0x0103 | Describe a light color |
| | state/03 | | and remaining time |
| | | | of a current signal light set |
| Dynamic | Lane function | 0x0201 | Describe a current |
| traffic | state/01 | | lane function of a |
| identifier/02 | | | variable lane, whether |
| | | | it is a transition state, |
| | | | and the like |
| | Lane/ramp control | 0x0202 | Describe closure or |
| | information/02 | | opening information of |
| | | | a current lane/ramp |
| Signal control | Current signal | 0x0301 | Describe a light |
| parameter/03 | solution color step | | color and duration of a |
| | information/01 | | current operating solution |
| | Next cycle signal | 0x0302 | Describe a light color |
| | solution color step | | and duration of a new |
| | information/02 | | solution that the signal |
| | | | machine runs in the |
| | | | next cycle |
| Traffic | Traffic flow | 0x0401 | Describe a traffic |
| state/04 | information/01 | | flow of each lane, an |
| | | | average speed, a |
| | | | queue length, and the like |
| | Traffic operating | 0x0402 | Describe a traffic operating |
| | state information/02 | | state of each lane |
| Other | Vehicle operating | 0x0501 | Describe current |
| information/ | state information/01 | | position coordinates, a |
| 05 | | | speed, a head direction |
| | | | angle, and the like |
| | | | of a driving vehicle |
| | Traffic incident | 0x0502 | Describe a traffic |
| | information/02 | | accident, a road obstacle, |
| | | | and the like reported |
| | | | by a vehicle |
| Signal | Signal priority | 0x0601 | Describe a signal priority |
| priority/06 | request and | | request reported |
| | response/01 | | by a vehicle, a response |
| | | | of a road traffic |
| | | | signal control machine, |
| | | | and the like |

The embodiments of this application stipulate the data structure of the signal priority request packet, so that when the signal priority request packet is being processed, how to process the signal priority request packet can be clarified based on information in each part of the data structure, providing a data standard for traffic control of vehicles, which is conducive to flexible and convenient traffic control of the vehicles.

S302: The first road side unit transmits the first signal priority request packet.

In some embodiments, after the first road side unit generates the first signal priority request packet, the first signal priority request packet may be transmitted to the first road traffic signal control machine. In this case, the first data sheet may include the first receiver identifier, and the method of transmitting the first signal priority request packet may include that when the first receiver identifier is the identifier of the first road traffic signal control machine, the first signal priority request packet is transmitted to the first road traffic signal control machine.

For example, any road traffic signal control machine may be configured with an identifier in advance, and the identifier can uniquely correspond to a road traffic signal control machine. The first road side unit has a plurality of road traffic signal control machines and corresponding identifiers thereof stored therein. When the first road side unit needs to transmit the first signal priority request packet to the first road traffic signal control machine, the identifier corresponding to the first road traffic signal control machine may be used as the first receiver identifier, and the first receiver identifier is written into the first data sheet. For example, the structure of the first data sheet may be as shown in the data sheet structure shown in FIG. 6, and the receiver identifier in FIG. 6 is the foregoing first receiver identifier. In addition, as shown in FIG. 6, the first data sheet may further include a transmitter identifier, and the transmitter identifier is an identifier corresponding to the road side unit that transmits the signal priority request packet. For the first road side unit, the transmitter identifier is the first transmitter identifier, that is, the identifier corresponding to the first road side unit.

In this embodiment of this application, the receiver of the first signal priority request packet may be determined based on the first receiver identifier, and it is known which device the first road side unit directly communicates with. When the first receiver identifier is the identifier of the first road traffic signal control machine, the first road side unit may directly communicate with the first road traffic signal control machine, thereby improving the processing efficiency of the first signal priority request packet, and improving the efficiency of traffic control.

S303: A first road traffic signal control machine receives the first signal priority request packet.

For example, if the first signal priority request packet includes the first receiver identifier, the first road traffic signal control machine may correspond to the first receiver identifier. If the first signal priority request packet includes the first transmitter identifier, the first road traffic signal control machine may determine the road side unit that transmits the signal priority request packet through the transmitter identifier. In some embodiments, the first road traffic signal control machine may have a plurality of road side units and corresponding unique identifiers thereof stored therein. The first road traffic signal control machine may match the identifiers of the plurality of road side unit through the first transmitter identifier in the received first signal priority request packet. If the identifier of the first road side unit can be matched successfully, then the first road traffic signal control machine may determine that the first road side unit is the road side unit that transmits the first signal priority request packet.

S304: The first road traffic signal control machine generates a first signal priority response packet based on the first signal priority request packet, the first signal priority response packet including N signal priority responses respectively for the N signal priority requests, and the N signal priority responses including information configured for indicating to control a traffic management and control device of the first intersection.

In some embodiments, each signal priority response includes at least one of entrance information, priority response information, priority response type information, and priority duration information at the first intersection of the corresponding signal priority response.

For example, the information that may be included in a signal priority response may be as shown in Table 4, where the entrance information in the signal priority response may be the same as the entrance information included in the received signal priority request, so that a quantity of bytes, a value, and a description may also be the same as the number of bytes, the value, and the description of the entrance in the signal priority response in Table 1, as previously described. For example, the priority response is configured for indicating a state in which the road traffic signal control machine responds to the received signal priority request, where 0x01 may correspond to a priority request being allowed, 0x02 may correspond to a priority request being rejected, 0x03 may correspond to a signal machine being busy (the road traffic signal control machine may also be referred to as the signal machine for short), 0x04 may correspond to the instruction not being recognized, and 0x05 may correspond to data verification error. Therefore, a quantity of bytes of the priority response may be 1, and a value range may be 0 to 5. Values other than 0 to 5 are not limited in the embodiments of this application, and information indicated by other values may be retained temporarily.

For example, the priority response type information is configured for indicating a response type of the road traffic signal control machine to the signal priority request packet. The priority response type may include early red light interruption, green light extension, phase maintenance, phase insertion, and the like. For example, 0x01 may correspond to the early red light interruption, 0x02 may correspond to the green light extension, 0x03 may correspond to the phase maintenance, and 0x04 may correspond to the phase insertion. Therefore, a quantity of bytes of the priority response type may be 1, and a value range may be 0 to 4. Values other than 0 to 4 are not limited in the embodiments of this application, and information indicated by other values may be retained temporarily. For example, the phase maintenance is configured for maintaining a phase of a current signal light. The phase insertion is configured for inserting a new signal light phase between the current signal light phases to meet the corresponding signal priority request.

For example, the priority duration information is a signal priority duration obtained by responding based on the request priority duration information in the signal priority request packet. The priority duration may be the same as the duration of the request priority duration information. In Table 4, a quantity of bytes of the priority duration may be one byte, and a value may be from 0 to 255, and a unit is a second.

TABLE 4

| Num- | | Number of | | |
|---|---|---|---|---|
| ber | Name | bytes | Value | Description |
| 1 | Entrance | 2 | 0 | Road entrance at which |
| | | | | a signal is preferential. |
| | | | | An integer, which is a |
| | | | | clockwise rotation angle |
| | | | | starts from the geographical |
| | | | | north direction, and |
| | | | | a unit is a degree (°). The |
| | | | | value 0 represents 0 |
| | | | | degrees to 1 degree, |
| | | | | including 0 degrees and |
| | | | | excluding 1 degree, |
| | | | | the same below |
| 2 | Priority | 1 | 1 to 5 | 0x01 priority request allowed |
| | response | | | 0x02 priority request rejected |
| | | | | 0x03 signal machine busy |
| | | | | 0x04 instruction cannot |
| | | | | be recognized |
| | | | | 0x05 data verification error |
| | | | | Others reserved |
| 3 | Priority | 1 | 1 to 4 | 0x01 early red |
| | response | | | light interruption |
| | type | | | 0x02 green light extension |
| | | | | 0x03 phase maintenance |
| | | | | 0x04 phase insertion |
| | | | | Others reserved |
| 4 | Priority | 1 | 0 to | A duration of a signal |
| | duration | | 255 | priority, where a unit is a |
| | | | | second |

In some embodiments, the first signal priority response packet further includes operation type information of the signal priority response. For example, the first signal priority response packet may be transmitted in the form of an information frame. For example, the operation type of the signal priority response may belong to setting a response, and the encoding of the operation type information of the signal priority response may be 0x84 (hexadecimal).

For example, the corresponding message types of the signal priority request and response, and the corresponding operation types of the signal priority request and the signal priority response may be as shown in Table 5. The operation type of the signal priority request is setting a request. The operation type of setting a request is actively transmitted by a requester. Information format is to comply with rules in Table 6 below. The requester in this embodiment of this application is the first road side unit. The operation type of the signal priority response is setting a response. The operation type of setting a response is that the signal machine responds immediately after receiving the request. Information format is to comply with rules in Table 7 below.

TABLE 5

| Num- | Message | Operation | |
|---|---|---|---|
| ber | type | type | Explanation |
| 1 | Signal | Set a request | A requester actively |
| | priority | | performs transmission, and |
| | request and | | information format of a data |
| | response | | sheet is to comply with |
| | | | rules in Table 6 |
| 2 | | Set a response | A signal machine responds |
| | | | immediately after receiving |
| | | | the request and information |
| | | | format of a data sheet is to |
| | | | comply with rules in Table 7 |

The embodiments of this application stipulate the content in the signal priority request, thereby enriching the content in the signal priority request, and making traffic control of the vehicle more flexible and convenient.

In some embodiments, the first signal priority response packet further includes an object identifier of the first signal priority response packet; and the object identifier may indicate that the first signal priority response packet is configured for describing a response of a road traffic signal control machine to the first signal priority request packet. For example, the object identifier of the first signal priority response packet may include classification of the object identifier and a name of the object identifier, which is the same as the object identifier of the first signal priority request packet. For example, the object identifier of the first signal priority request packet may be classified as signal priority, and a corresponding code may be set to 06. The name of the object identifier of the first signal priority response packet may be signal priority request, and the corresponding code may be set to 01. Therefore, a hexadecimal value of the object identifier corresponding to the first signal priority request packet is 0x0601. The object identifier of the first signal priority response packet may correspond to the signal priority object identifier classification in Table 3.

In this embodiment of this application, since the first signal priority response packet includes the object identifier, based on the object identifier, the first signal priority response packet configured for describing a response of the road traffic signal control machine to the first signal priority request packet may be identified, so that the first signal priority response packet may be identified promptly and accurately and traffic control of the vehicle is implemented based on the first signal priority response packet.

In an exemplary embodiment, Table 6 shows an information format of a data sheet corresponding to a signal priority request, where a code of the operation type is 0x81, and a code of the object identifier is 0x0601. The message content may be determined according to the content of the signal priority request packet specified in Table 2, as previously described.

TABLE 6

| | | | | | | | | | | | |
|---|---|---|---|---|---|---|---|---|---|---|---|
| Link | Transmitter | Receiver | | Survival | Protocol | Operation | Object | Signature | | Message | Signature |
| code | identifier | identifier | Timestamp | time | version | type | identifier | tag | Reserved | content | certificate |

| | | |
|---|---|---|
| 0x81 | 0x0601 | Comply |
| | | with |
| | | rules in |
| | | Table 2 |

In an exemplary embodiment, Table 7 shows an information format of a data sheet corresponding to a signal priority response, where a code of the operation type is 0x84, and a code of the object identifier is 0x0601. For the message content, refer to the content of the signal priority response packet shown in Table 8 below.

TABLE 7

| | | | | | | | | | | | |
|---|---|---|---|---|---|---|---|---|---|---|---|
| Link | Transmitter | Receiver | | Survival | Protocol | Operation | Object | Signature | | Message | Signature |
| code | identifier | identifier | Timestamp | Time | version | Type | identifier | tag | Reserved | content | certificate |

| | | |
|---|---|---|
| 0x84 | 0x0601 | Comply |
| | | with |
| | | rules in |
| | | Table 8 |

In some embodiments, the first signal priority response packet further includes information about a response packet length and/or signal priority response quantity information of the first signal priority response packet.

For example, the information about the response packet length of the first signal priority response packet is configured for indicating a total quantity of bytes of messages of the N signal priority responses included in the first signal priority response packet. The signal priority response quantity information of the first signal priority response packet may indicate a quantity of signal priority responses included in the first signal priority response packet. For example, the quantity of signal priority responses may be the same as the quantity of signal priority requests included in the first signal priority request packet.

The content of a possible signal priority request packet may be shown in Table 8. The signal priority response packet in Table 8 includes a message length, a priority response quantity, and a priority response. The message length is configured for indicating the information about the response packet length, and the priority response quantity is configured for indicating the signal priority response quantity information. The priority response is configured for indicating the signal priority response. The message length may be represented by an integer ranging from 1 to 65535. A quantity of bytes of the message length may be 2. The priority response quantity may be represented by an integer ranging from 1 to 20. A quantity of bytes of the priority response quantity may be 1. In addition, the priority response in Table 8 may include 1 to N signal priority responses. For the information that may be included in each signal priority response, refer to Table 4, and details are not described herein again.

TABLE 8

| | | Number | | |
|---|---|---|---|---|
| Number | Name | of bytes | Value | Description |
| 1 | Message length | 2 | 1 to 65535 | Integer, a total quantity |
| | | | | of bytes in the message |
| 2 | Priority | 1 | 1 to 20 | Integer, a quantity of |
| | response | | | signal priority responses |
| | quantity | | | |
| 3 | Priority | | | Including 1 to N signal |
| | response | | | priority responses |

The embodiments of this application stipulate the content in the signal priority response, thereby enriching the content in the signal priority response. In addition, whether the first signal priority response exceeds a processing limit of the first road side unit is verified based on the information about the response packet length, to ensure normal traffic control. In fact, each signal priority request corresponds to a signal priority response. The quantity of signal priority responses may be verified based on the signal priority response quantity information to avoid missing responses to the signal priority requests and ensure the flexibility and accuracy of traffic control for the vehicle.

In some embodiments, the first signal priority response packet is based on the data sheet exchange manner of the information frame encapsulation, and the first signal priority response packet includes the frame start, a second data sheet, a second check code, and the frame end; the second data sheet includes at least one of a second link code, a second transmitter identifier, a second receiver identifier, a second timestamp, second survival time, a second protocol version, operation type information of a signal priority response, the object identifier of the first signal priority response packet, a second signature tag, second reserved information, second message content, and a second signature certificate; and the second message content includes the N signal priority responses.

In an exemplary embodiment, an information frame encapsulation method of the first signal priority response packet is consistent with that of the first signal priority request packet. For the structure of the information frame, refer to FIG. 5, and details are not described herein again. In addition, a structure of the second data sheet is consistent with that of the first data sheet. For the structure of the second data sheet and the related descriptions of the second data sheet, refer to FIG. 6 and the accompanying drawing descriptions corresponding to FIG. 6, and details are not described herein again.

The embodiments of this application stipulate the data structure of the signal priority response packet, so that when the signal priority response packet is being processed, how to process the signal priority response packet can be clarified based on information in each part of the data structure, providing a data standard for traffic control of vehicles, which is conducive to flexible and convenient traffic control of the vehicles.

S305: The first road traffic signal control machine transmits the first signal priority response packet.

For example, when the first road traffic signal control machine generates the first signal priority response packet based on the first signal priority request packet transmitted by the first road side unit, the first signal priority response packet may be returned to the first road side unit.

In a possible implementation, the first road traffic signal control machine may use a unique identifier corresponding to the first road traffic signal control machine as a transmitter identifier of the first signal priority response packet, and use a unique identifier corresponding to the first road side unit as a receiver identifier of the first signal priority response packet. Then, the first road traffic signal control machine may transmit the first signal priority response packet carrying the foregoing transmitter identifier and the receiver identifier to the first road side unit.

In this embodiment of this application, the transmitter of the first signal priority request packet may be determined based on the first transmitter identifier, and it is known which device the first road traffic signal control machine directly communicates with. When the first transmitter identifier is the identifier of the first road side unit, the first road traffic signal control machine may directly communicate with the corresponding first road side unit, which improves the processing efficiency and accuracy of the first signal priority response packet, thereby improving the efficiency of traffic control.

S306: Receive the first signal priority response packet returned for the first signal priority request packet, the first signal priority response packet including the N signal priority responses respectively for the N signal priority requests, and the N signal priority responses including the information configured for indicating the first road traffic signal control machine of the first intersection to control the traffic management and control device of the first intersection.

In an exemplary embodiment, the traffic management and control device may be a device installed at the first intersection and configured for traffic control, and traffic information collection and release. In a possible implementation, the traffic management and control device may be a light set, or the traffic management and control device may be a tidal lane sign, a road traffic inducing variable information sign, and the like.

In the technical solutions provided in the embodiments of this application, each intersection has a corresponding road side unit. Using the first road side unit as an example, the first road side unit can first generate a first signal priority request packet, the first signal priority request packet includes N signal priority requests, where N is a positive integer greater than or equal to 1, and when N is greater than 1, the N signal priority requests are configured for indicating signal priority requests initiated by a same type of vehicles at different entrances of the first intersection, or signal priority requests initiated by different types of vehicles in different entrance directions of the first intersection, or signal priority requests initiated by different types of vehicles at a same entrance of the first intersection, or signal priority requests initiated by a same type of vehicles at a same entrance of the first intersection, thereby supporting control of various possible signal priority situations. Next, the first road side unit may transmit the first signal priority request packet, and a corresponding first road traffic signal control machine may receive the first signal priority request packet. In this way, the first road traffic signal control machine can respond to the first signal priority request and generate the first signal priority response packet. The first signal priority response packet includes N signal priority responses respectively for the N signal priority requests, and the N signal priority responses include information configured for indicating a first road traffic signal control machine of the first intersection to control a traffic management and control device of the first intersection, so that the priority passage of the vehicle can be controlled based on the N signal priority responses. The road traffic signal control machine at each intersection can respond to the received signal priority request to control the priority passage of the vehicle at the intersection, thereby achieving the objective of flexibly controlling the priority passage of the vehicle.

In addition, since the first road side unit in this embodiment of this application may directly communicate with the first road traffic signal control machine, a communication process is simplified, thereby improving the efficiency of traffic control.

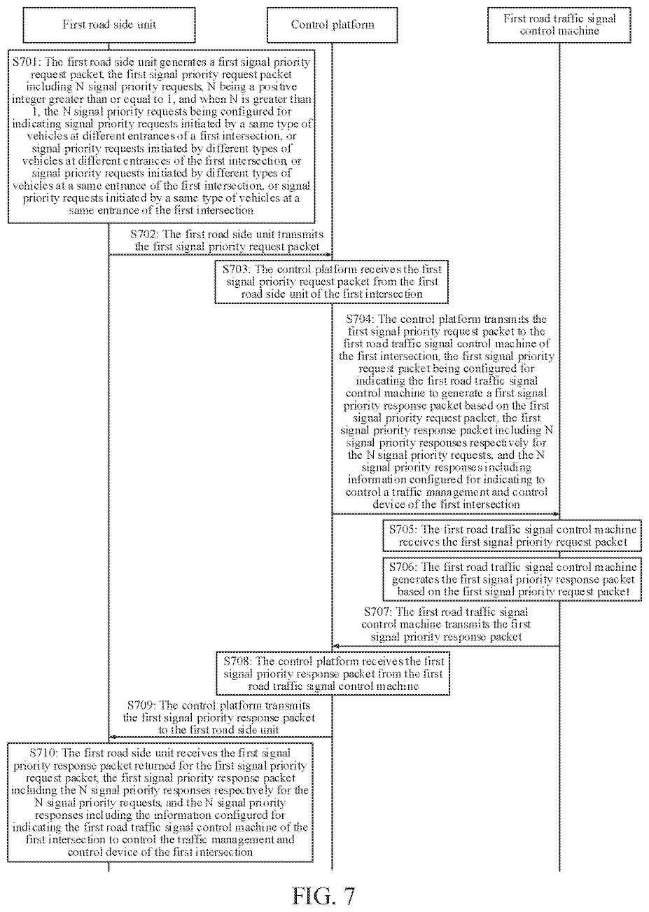

FIG. 7 is a flowchart of another traffic control method according to an embodiment of this application. In this embodiment of this application, an example in which this method is applied to the intersection between the first road side unit of the first intersection, the first road traffic signal control machine of the first intersection, and the control platform is used.

S701: A first road side unit generates a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of a first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection. For this operation, refer to S301. Details are not described herein again.

S702: The first road side unit transmits the first signal priority request packet.

In some embodiments, the transmitting the first signal priority request packet includes: when the first data sheet includes the first receiver identifier and the first receiver identifier is an identifier of a control platform, transmitting the first signal priority request packet to the control platform, where the first signal priority request packet is configured for indicating the control platform to match, based on the first transmitter identifier, the first road traffic signal control machine corresponding to the first road side unit, and transmit the first signal priority request packet to the first road traffic signal control machine.

For example, any control platform may be configured with an identifier in advance, and the identifier may uniquely correspond to a control platform. The first road side unit has the control platform and the corresponding identifier thereof stored therein. When the first road side unit needs to transmit the first signal priority request packet to the control platform, the unique identifier corresponding to the control platform may be used as the first receiver identifier, and the first receiver identifier is written into the first data sheet. For example, the structure of the first data sheet may be as shown in the data sheet structure shown in FIG. 6, and the receiver identifier in FIG. 6 is the foregoing first receiver identifier. In addition, the first data sheet may further include a transmitter identifier. For the first road side unit, the first transmitter identifier is the identifier corresponding to the first road side unit. The control platform may store a plurality of road side units and road traffic signal control machines corresponding to the road side units.

In this embodiment of this application, the receiver of the first signal priority request packet may be determined based on the first receiver identifier, and it is known which device the first road side unit directly communicates with. When the first receiver identifier is the identifier of the control platform, the first road side unit may communicate with the first road traffic signal control machine through the control platform. In this case, different road side units may communicate with the corresponding first road traffic signal control machine through the control platform respectively, so that the control platform may perform traffic control on road traffic signal control machines at a plurality of intersections at the same time, to facilitate the response to a plurality of intersection situations, thereby achieving the objective of flexibly controlling the priority passage of the vehicles.

S703: A control platform receives the first signal priority request packet from the first road side unit of the first intersection.

In an exemplary embodiment, the control platform may match, based on the first transmitter identifier, the first road traffic signal control machine corresponding to the first road side unit. Alternatively, the control platform may determine the corresponding first road traffic signal control machine based on the first signal priority request packet. Then, the first signal priority request packet may be transmitted to the first road traffic signal control machine.

The control platform is not limited in the embodiments of this application, provided that the control platform can forward the signal priority request packet and the signal priority response packet. For example, the control platform may be a C-V2X (Cellular-Vehicle to Everything, cellular vehicle networking) cloud control platform.

S704: The control platform transmits the first signal priority request packet to the first road traffic signal control machine of the first intersection, the first signal priority request packet being configured for indicating the first road traffic signal control machine to generate a first signal priority response packet based on the first signal priority request packet, the first signal priority response packet including N signal priority responses respectively for the N signal priority requests, and the N signal priority responses including information configured for indicating to control a traffic management and control device of the first intersection.

In some embodiments, the information is included in the first signal priority request packet according to S301, as previously described.

S705: The first road traffic signal control machine receives the first signal priority request packet.

In some embodiments, the first road traffic signal control machine may receive the first signal priority request packet forwarded by the control platform.

S706: The first road traffic signal control machine generates a first signal priority response packet based on the first signal priority request packet.

In some embodiments, the operation of the first road traffic signal control machine generating the first signal priority response packet based on the first signal priority request packet is performed according to S304, as previously described.

S707: The first road traffic signal control machine transmits the first signal priority response packet.

For example, the first signal priority response packet may further include a transmitter identifier and a receiver identifier of the first signal priority response packet. The transmitter identifier of the first signal priority response packet may be the identifier corresponding to the first road traffic signal control machine. The receiver identifier in the first signal priority response packet corresponds to the control platform.

S708: The control platform receives the first signal priority response packet from the first road traffic signal control machine.

For example, the control platform may determine that the transmitter of the first signal priority response packet is the first road traffic signal control machine through the transmitter identifier in the first signal priority response packet.

S709: The control platform transmits the first signal priority response packet to the first road side unit.

In some embodiments, the control platform may match, based on the receiver identifier in the first signal priority request packet, the first road side unit corresponding to the receiver identifier. Alternatively, the control platform may determine the corresponding first road side unit based on the first signal priority response packet. Then, the control platform may transmit the first signal priority response packet to the first road side unit.

S710: The first road side unit receives the first signal priority response packet returned for the first signal priority request packet, the first signal priority response packet including the N signal priority responses respectively for the N signal priority requests, and the N signal priority responses including the information configured for indicating the first road traffic signal control machine of the first intersection to control the traffic management and control device of the first intersection.

In some exemplary embodiments, the operation of the first road side unit receiving the first signal priority response packet returned for the first signal priority request packet is performed according to S306, as previously described.

The method provided in this embodiment of this application can be implemented in an environment with a plurality of intersections. The road side unit may first transmit the signal priority request packet to the control platform, and then transmit the signal priority request packet to the corresponding road traffic signal control machine through the control platform. Therefore, the control platform may perform traffic control on the road traffic signal control machines of the plurality of intersections at the same time, thereby achieving the objective of flexibly controlling priority passage of the vehicles.

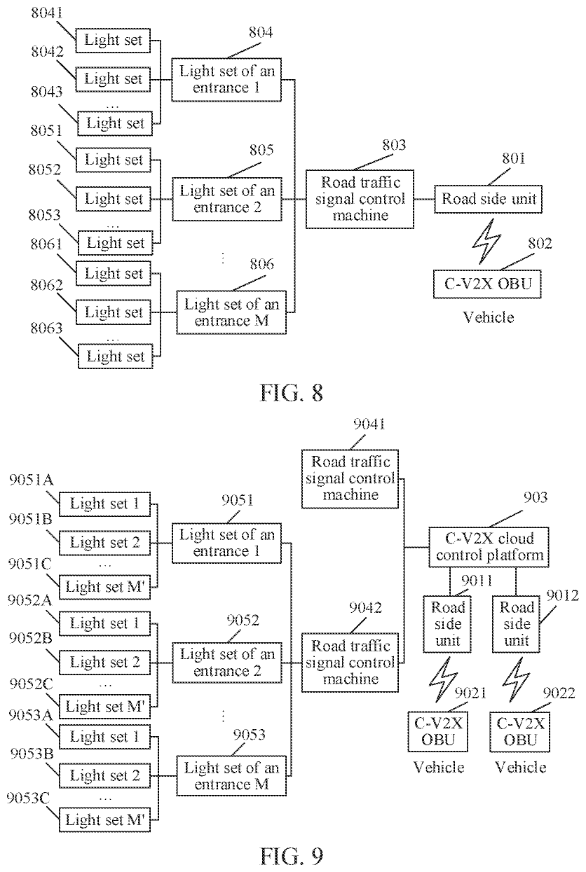

In some embodiments, a traffic control architecture diagram corresponding to the embodiment shown in FIG. 3 may be as shown in FIG. 8.

In FIG. 8, the road side unit 801 may be connected to the road traffic signal control machine 803 and a C-V2X OBU 802 (On Board Unit) included in the vehicle through C-V2X technology. The road side unit 801 may obtain a priority passage request of the vehicle through the C-V2X OBU 802 included in the vehicle. After the signal priority request packet is generated, the road side unit 801 may transmit the signal priority request packet to the road traffic signal control machine 803. The road traffic signal control machine 803 may be connected to a plurality of light sets of the entrance respectively, and each light set of the entrance may further be connected to a plurality of light sets. As shown in FIG. 8, the road traffic signal control machine 803 is connected to a light set 804 of an entrance 1, a light set 805 of an entrance 2, . . . , and a light set 806 of an entrance M (M is a positive integer) respectively, and each entrance light set may further be connected to a plurality of light sets respectively. As shown in FIG. 8, the light set 804 of the entrance 1 is connected to a plurality of light sets of a light set 8041, a light set 8042, . . . , and a light set 8043 respectively; the light set 805 of the entrance 2 is connected to a plurality of light sets of a light set 8051, a light set 8052, . . . , and a light set 8053 respectively; and the light set 806 of the entrance M is connected to a plurality of light sets of a light set 8061, a light set 8062, . . . , and a light set 8063 respectively. After the road traffic signal control machine 803 responds to the signal priority request packet, the plurality of entrance light sets may be controlled to achieve traffic control. In addition, the road traffic signal control machine 803 may return the signal priority response packet to the road side unit 801.

In some embodiments, a traffic control architecture diagram corresponding to the embodiment shown in FIG. 7 may be as shown in FIG. 9. FIG. 9 may be used for trunk line or area signal priority (that is, there are a plurality of intersections).

In FIG. 9, a plurality of road side units may be connected to the C-V2X cloud control platform and the C-V2X OBU (On Board Unit) included in the vehicle respectively through C-V2X technology. Any road side unit may obtain the priority passage request of the vehicle through the C-V2X OBU included in the vehicle. As shown in FIG. 9, both a road side unit 9011 and a road side unit 9012 may be connected to a C-V2X cloud control platform 903. In addition, the road side unit 9011 may be connected to a C-V2X OBU9021, and the road side unit 9012 may be connected to a C-V2X OBU9022. After the signal priority request packet is generated, the road side unit 9011 and the road side unit 9012 may transmit the signal priority request packet to the C-V2X cloud control platform 903. The C-V2X cloud control platform 903 may be configured to connect to a road traffic signal control machine 9041 and a road traffic signal control machine 9042, and the C-V2X cloud control platform 903 may transmit the signal priority request packet to the corresponding road traffic signal control machine. Both the road traffic signal control machine 9041 and the road traffic signal control machine 9042 may be connected to a plurality of light sets of the entrance respectively, and each light set of the entrance may further be connected to a plurality of light sets. Using the road traffic signal control machine 9042 as an example, as shown in FIG. 9, the road traffic signal control machine 9042 is connected to a light set 9051 of an entrance 1, a light set 9052 of an entrance 2, . . . , and a light set 9053 of an entrance M respectively, and each entrance light set may further be connected to a plurality of light sets respectively. As shown in FIG. 9, the light set 9051 of the entrance 1 is connected to a plurality of light sets of a light set 9051A (such as a light set 1 included in the light set of the entrance 1 in FIG. 9), a light set 9051B (such as a light set 2 included in the light set of the entrance 1 in FIG. 9), . . . , and a light set 9051C (such as a light set M′ included in the light set of the entrance 1 in FIG. 9) respectively; the light set 9052 of the entrance 2 is connected to a plurality of light sets of a light set 9052A (such as a light set 1 included in the light set of the entrance 2 in FIG. 9), a light set 9052B (such as a light set 2 included in the light set of the entrance 2 in FIG. 9), . . . , and a light set 9052C (such as a light set M′ included in the light set of the entrance 2 in FIG. 9) respectively; and the light set 9053 of the entrance M is connected to a plurality of light sets of a light set 9053A (such as a light set 1 included in the light set of the entrance M in FIG. 9), a light set 9053B (such as a light set 2 included in the light set of the entrance M in FIG. 9), . . . , and a light set 9053C (such as a light set M′ included in the light set of the entrance M in FIG. 9) respectively. After the road traffic signal control machine responds to the signal priority request packet, the plurality of entrance light sets may be controlled to achieve traffic control. In addition, the road traffic signal control machine may return the signal priority response packet to the C-V2X cloud control platform. The C-V2X cloud control platform may forward the signal priority response packet to the corresponding road side unit. Under this architecture, the distinction between a plurality of road traffic signal control machines needs to rely on the transmitter identifier and the receiver identifier, and the identifiers may determine the unique identity of the transmitter and the receiver.

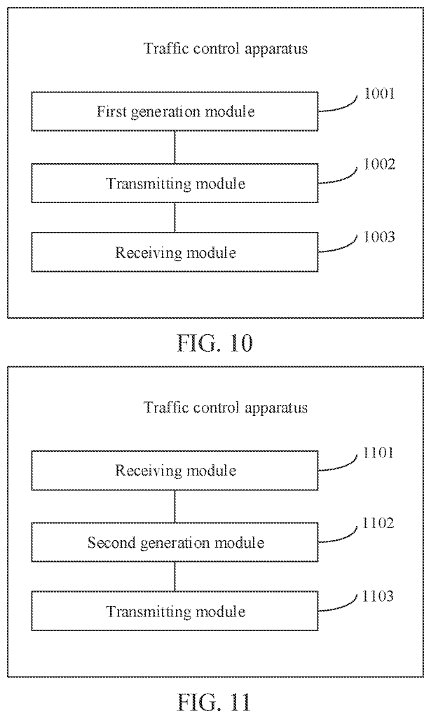

FIG. 10 is a schematic diagram of a traffic control apparatus according to an embodiment of this application. The apparatus is performed by a first road side unit of a first intersection. As shown in FIG. 10, the apparatus includes a first generation module 1001, a transmitting module 1002, and a receiving module 1003.

The first generation module 1001 is configured to generate a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles in different entrance directions of the first intersection, or signal priority requests initiated by different types of vehicles at a same entrance of the first intersection, or signal priority requests initiated by a same type of vehicles at a same entrance of the first intersection.

The transmitting module 1002 is configured to transmit the first signal priority request packet.

The receiving module 1003 is configured to receive a first signal priority response packet returned for the first signal priority request packet, the first signal priority response packet including N signal priority responses respectively for the N signal priority requests, and the N signal priority responses including information configured for indicating a first road traffic signal control machine of the first intersection to control a traffic management and control device of the first intersection.

In some exemplary embodiments, each signal priority request includes entrance information and request priority manner information at the first intersection.

In some exemplary embodiments, each signal priority request further includes at least one of request priority level information, request priority duration information, vehicle type information, vehicle location information, information about a distance between a vehicle and the first intersection, information about estimated arrival time at which a vehicle arrives at the first intersection, and information about a quantity of passengers on a vehicle.

In some exemplary embodiments, the first signal priority request packet further includes operation type information of the signal priority request.

In some exemplary embodiments, the first signal priority request packet further includes an object identifier of the first signal priority request packet; and the object identifier is configured for indicating that the first signal priority request packet is configured for describing the signal priority request reported by a vehicle.

In some exemplary embodiments, the first signal priority request packet further includes information about a request packet length and/or signal priority request quantity information of the first signal priority request packet.

In some exemplary embodiments, the first signal priority request packet is based on a data sheet exchange manner of information frame encapsulation, and the first signal priority request packet includes a frame start, a first data sheet, a first check code, and a frame end; the first data sheet includes at least one of a first link code, a first transmitter identifier, a first receiver identifier, a first timestamp, first survival time, a first protocol version, operation type information of a signal priority request, the object identifier of the first signal priority request packet, a first signature tag, first reserved information, first message content, and a first signature certificate; and the first message content includes the N signal priority requests.

In some exemplary embodiments, the transmitting module 1002 is configured to transmit, when the first data sheet includes the first receiver identifier and the first receiver identifier is an identifier of a control platform, the first signal priority request packet to the control platform, where the first signal priority request packet is configured for indicating the control platform to match, based on the first transmitter identifier, the first road traffic signal control machine corresponding to the first road side unit, and transmit the first signal priority request packet to the first road traffic signal control machine; or transmit, when the first receiver identifier is an identifier of the first road traffic signal control machine, the first signal priority request packet to the first road traffic signal control machine.

In some exemplary embodiments, each signal priority response includes at least one of the entrance information, priority response information, priority response type information, and priority duration information at the first intersection.

In some exemplary embodiments, the first signal priority response packet further includes operation type information of the signal priority response.

In some exemplary embodiments, the first signal priority response packet further includes an object identifier of the first signal priority response packet; and the object identifier is configured for indicating that the first signal priority response packet is configured for describing a response of a road traffic signal control machine to the first signal priority request packet.

In some exemplary embodiments, the first signal priority response packet further includes information about a response packet length and/or signal priority response quantity information of the first signal priority response packet.

In some exemplary embodiments, the first signal priority response packet is based on the data sheet exchange manner of the information frame encapsulation, and the first signal priority response packet includes the frame start, a second data sheet, a second check code, and the frame end; the second data sheet includes at least one of a second link code, a second transmitter identifier, a second receiver identifier, a second timestamp, second survival time, a second protocol version, operation type information of a signal priority response, the object identifier of the first signal priority response packet, a second signature tag, second reserved information, second message content, and a second signature certificate; and the second message content includes the N signal priority responses.

In some exemplary embodiments, the receiving module 1003 is further configured to receive a signal priority request transmitted by at least one vehicle; and

the first generation module 1001 is configured to determine the first signal priority request packet based on the signal priority request transmitted by the at least one vehicle.

For the apparatus provided in the embodiments of this application, each intersection has a corresponding road side unit. Using the first road side unit as an example, the first road side unit can first generate a first signal priority request packet, the first signal priority request packet includes N signal priority requests, where N is a positive integer greater than or equal to 1, and when N is greater than 1, the N signal priority requests are configured for indicating signal priority requests initiated by a same type of vehicles at different entrances of the first intersection, or signal priority requests initiated by different types of vehicles in different entrance directions of the first intersection, or signal priority requests initiated by different types of vehicles at a same entrance of the first intersection, or signal priority requests initiated by a same type of vehicles at a same entrance of the first intersection, thereby supporting control of various possible signal priority situations. Next, the first road side unit may transmit the first signal priority request packet, and a corresponding first road traffic signal control machine may receive the first signal priority request packet. In this way, the first road traffic signal control machine can respond to the first signal priority request and generate the first signal priority response packet. The first signal priority response packet includes N signal priority responses respectively for the N signal priority requests, and the N signal priority responses include information configured for indicating a first road traffic signal control machine of the first intersection to control a traffic management and control device of the first intersection, so that the priority passage of the vehicle can be controlled based on the N signal priority responses. The road traffic signal control machine at each intersection can respond to the received signal priority request to control the priority passage of the vehicle at the intersection, thereby achieving the objective of flexibly controlling the priority passage of the vehicle.

FIG. 11 is a schematic diagram of a traffic control apparatus according to an embodiment of this application. The apparatus is performed by a first road traffic signal control machine of a first intersection. As shown in FIG. 11, the apparatus may include a receiving module 1101, a second generation module 1102, and a transmitting module 1103.

The receiving module 1101 is configured to receive a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection.

The second generation module 1102 is configured to generate a first signal priority response packet based on the first signal priority request packet, the first signal priority response packet including N signal priority responses respectively for the N signal priority requests, and the N signal priority responses including information configured for indicating to control a traffic management and control device of the first intersection.

The transmitting module 1103 is configured to transmit the first signal priority response packet.

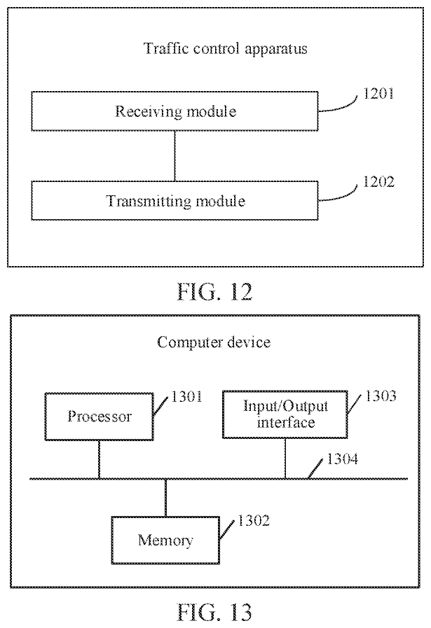

FIG. 12 is a schematic diagram of a traffic control apparatus according to an embodiment of this application. The apparatus is performed by a control platform. As shown in FIG. 12, the apparatus may include a receiving module 1201 and a transmitting module 1202.

The receiving module 1201 is configured to receive a first signal priority request packet from a first road side unit of a first intersection, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection.

The transmitting module 1202 is configured to transmit the first signal priority request packet to the first road traffic signal control machine of the first intersection, the first signal priority request packet being configured for indicating the first road traffic signal control machine to generate a first signal priority response packet based on the first signal priority request packet, the first signal priority response packet including N signal priority responses respectively for the N signal priority requests, and the N signal priority responses including information configured for indicating to control a traffic management and control device of the first intersection.

The receiving module 1201 is further configured to receive the first signal priority response packet from the first road traffic signal control machine.

The transmitting module 1202 is further configured to transmit the first signal priority response packet to the first road side unit.

The apparatus provided in this embodiment of this application can implemented in an environment with a plurality of intersections. The road side unit may first transmit the signal priority request packet to the control platform, and then transmit the signal priority request packet to the corresponding road traffic signal control machine through the control platform. Therefore, the control platform may perform traffic control on the road traffic signal control machines of the plurality of intersections at the same time.

FIG. 13 is a schematic diagram of a structure of a computer device according to an embodiment of this application. As shown in FIG. 13, the computer device in the embodiments of this application may include: one or more processors 1301, a memory 1302, and an input/output interface 1303. The processor 1301, the memory 1302, and the input/output interface 1303 are connected through a bus 1304. The memory 1302 is configured to store a computer program, and the computer program includes program instructions. The input/output interface 1403 is configured to receive data and output data, such as for data exchange between a host and the computer device, or for data exchange between virtual machines in the host; and the processor 1401 is configured to perform program instructions stored in the memory 1402.

The processor 1401 may perform the following operations: generating a first signal priority request packet, the first signal priority request packet including N signal priority requests, N being a positive integer greater than or equal to 1, and when N is greater than 1, the N signal priority requests being configured for indicating signal priority requests initiated by a same type of vehicles at different entrances of the first intersection, or signal priority requests initiated by different types of vehicles in different entrance directions of the first intersection, or signal priority requests initiated by different types of vehicles at a same entrance of the first intersection, or signal priority requests initiated by a same type of vehicles at a same entrance of the first intersection; transmitting the first signal priority request packet; and receiving a first signal priority response packet returned for the first signal priority request packet, the first signal priority response packet including N signal priority responses respectively for the N signal priority requests, and the N signal priority responses including information configured for indicating a first road traffic signal control machine of the first intersection to control a traffic management and control device of the first intersection.

Alternatively, the processor 1301 may perform the following operations: receiving the first signal priority request packet; and generating the first signal priority response packet based on the first signal priority request packet, the N signal priority responses being configured for indicating information about a traffic management and control device controlling the first intersection; and transmitting the first signal priority response packet.

Alternatively, the processor 1301 may perform the following operations: receiving the first signal priority request packet from the first road side unit of the first intersection; transmitting the first signal priority request packet to the first road traffic signal control machine of the first intersection, the first signal priority request packet being configured for indicating the first road traffic signal control machine to generate a first signal priority response packet based on the first signal priority request packet, the first signal priority response packet including N signal priority responses respectively for the N signal priority requests, and the N signal priority responses including information configured for indicating to control a traffic management and control device of the first intersection; receiving the first signal priority response packet from the first road traffic signal control machine; and transmitting the first signal priority response packet to the first road side unit.

In some implementations, the processor 1301 may be a central processing unit (CPU). The processor may further be another general-purpose processor, a digital signal processor (DSP), an application specific integrated circuit (ASIC), a field-programmable gate array (FPGA), or another programmable logic device, a discrete gate or a transistor logic device, a discrete hardware component, or the like. The general-purpose processor may be a microprocessor, or the processor may be any conventional processor, or the like.

The memory 1302 may include a read-only memory and a random access memory, and provides the processor 1301 and the input/output interface 1303 with instructions and data. A part of the memory 1302 may further include a non-volatile random access memory. For example, the memory 1302 may further store information about a device type.

In a specific implementation, the computer device may perform the implementations provided in operations in any of the foregoing method embodiments through built-in functional modules of the electronic device. For details, refer to the implementations provided in the foregoing operations in the figure of the foregoing method embodiments, and details are not described herein again.

Embodiments of this application provide a computer device, including: a processor, an input/output interface, and a memory. The processor obtains the computer program in the memory and executes each operation of the method shown in any one of the foregoing embodiments.

The embodiments of this application further provide a computer-readable storage medium, the computer-readable storage medium having a computer program stored therein, and the computer program being adapted to be loaded and executed by the processor to perform the traffic control method provided in each operation in any one of the foregoing embodiments. For a specific implementation, refer to each operation in any one of the foregoing embodiments. Details are not described herein again. In addition, the description of beneficial effects of the same method is not described herein again. For technical details that are not disclosed in the embodiments of the computer-readable storage medium of this application, refer to the method embodiments of this application. In an example, the computer program may be deployed to be executed on a computer device, or deployed to be executed on a plurality of computer devices at the same location, or deployed to be executed on a plurality of computer devices that are distributed in a plurality of locations and interconnected by using a communication network.

The computer-readable storage medium may be an audio data processing apparatus provided in any one of the foregoing embodiments or an internal storage unit of the computer device, for example, a hard disk or a main memory of the computer device. The computer-readable storage medium may alternatively be an external storage device of the computer device, for example, a removable hard disk, a smart media card (SMC), a secure digital (SD) card, or a flash card equipped on the computer device. Further, the computer-readable storage medium may further include both an internal storage unit and an external storage device of the computer device. The computer-readable storage medium is configured to store the computer program and another program and data that are required by the computer device. The computer-readable storage medium may further be configured to temporarily store data that has been output or data to be output.

The embodiments of this application further provide a computer program product or a computer program, the computer program product or the computer program including computer instructions, the computer instructions being stored in a computer-readable storage medium. A processor of a computer device reads the computer instructions from the computer-readable storage medium, and executes the computer instructions, so that the computer device performs the method provided in the various optional implementations in the foregoing embodiments.

In the specification, claims, and accompanying drawings of embodiments of this application, the terms “first” and “second” are intended to distinguish between different objects but do not indicate a particular order. In addition, terminologies “include” and any variations thereof are intended to indicate non-exclusive inclusion. For example, a process, method, apparatus, product, or device that includes a series of operations or units is not limited to the listed operations or units; and instead, further includes an operation or module that is not listed, or further includes another operation or unit that is intrinsic to the process, method, apparatus, product, or device.

A person of ordinary skill in the art may be aware that, in combination with the examples described in the embodiments disclosed in this specification, units and algorithm operations can be implemented by electronic hardware, computer software, or a combination thereof. To clearly describe the interchangeability between the hardware and the software, the foregoing has generally described compositions and operations of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

The method and the related apparatus provided in the embodiments of this application are described with reference to method flowcharts and/or schematic diagrams of structures provided in the embodiments of this application. Specifically, computer program instructions may be used to implement each process and/or each block in the method flowcharts and/or the schematic diagrams of structures and a combination of a process and/or a block in the flowcharts and/or the block diagrams. These computer program instructions may be provided to a general-purpose computer, a dedicated computer, an embedded processor, or a processor of another programmable application display device to generate a machine, so that the instructions executed by the computer or the processor of the another programmable application display device generate an apparatus for implementing a specific function in one or more processes in the flowcharts and/or in one or more blocks in the schematic diagrams of structures. These computer program instructions may alternatively be stored in a computer-readable memory that can instruct a computer or another programmable application display device to work in a specific manner, so that the instructions stored in the computer-readable memory generate an artifact that includes an instruction apparatus. The instruction apparatus implements a specific function in one or more procedures in the flowcharts and/or in one or more blocks in the schematic diagrams of structures. These computer program instructions may also be loaded onto a computer or another programmable application display device, so that a series of operations are performed on the computer or the another programmable device, thereby generating computer-implemented processing. Therefore, the instructions executed on the computer or the another programmable device provide steps for implementing a specific function in one or more processes in the flowcharts and/or in one or more blocks in the schematic structural diagrams.

What is disclosed above is merely exemplary embodiments of this application, and certainly is not intended to limit the protection scope of this application. Therefore, equivalent variations made in accordance with the claims of this application shall fall within the scope of this application.

What is claimed is:

1. A traffic control method, performed by a first road side unit of a first intersection, the method comprising:
generating a first signal priority request packet, the first signal priority request packet comprising N signal priority requests, N being a positive integer greater than or equal to 1, and when N is greater than 1, the N signal priority requests being configured to indicate signal priority requests initiated by a same type of vehicles at different entrances of the first intersection, or signal priority requests initiated by different types of vehicles in different entrance directions of the first intersection, or signal priority requests initiated by different types of vehicles at a same entrance of the first intersection, or signal priority requests initiated by a same type of vehicles at a same entrance of the first intersection;
transmitting the first signal priority request packet; and
receiving a first signal priority response packet returned for the first signal priority request packet, the first signal priority response packet comprising N signal priority responses respectively for the N signal priority requests, and the N signal priority responses comprising information configured to indicate a first road traffic signal control machine of the first intersection to control a traffic management and control device of the first intersection.

2. The method according to claim 1, wherein each signal priority request comprises entrance information and request priority manner information of the first intersection.

3. The method according to claim 1, wherein each signal priority request further comprises at least one of request priority level information, request priority duration information, vehicle type information, vehicle location information, information about a distance between a vehicle and the first intersection, information about estimated arrival time at which a vehicle arrives at the first intersection, and information about a quantity of passengers on a vehicle.

4. The method according to claim 1, wherein the first signal priority request packet further comprises an object identifier of the first signal priority request packet; and
the object identifier is configured to indicate that the first signal priority request packet is configured to describe the signal priority request reported by a vehicle.

5. The method according to claim 1, wherein the first signal priority request packet is based on a data sheet exchange manner of information frame encapsulation, and the first signal priority request packet comprises a frame start, a first data sheet, a first check code, and a frame end;
the first data sheet comprises at least one of a first link code, a first transmitter identifier, a first receiver identifier, a first timestamp, a first survival time, a first protocol version, operation type information of a signal priority request, the object identifier of the first signal priority request packet, a first signature tag, first reserved information, first message content, and a first signature certificate; and
the first message content comprises the N signal priority requests.

6. The method according to claim 5, wherein the transmitting the first signal priority request packet comprises:
when the first data sheet comprises the first receiver identifier and the first receiver identifier is an identifier of a control platform, transmitting the first signal priority request packet to the control platform, wherein the first signal priority request packet is configured to indicate the control platform to match, based on the first transmitter identifier, the first road traffic signal control machine corresponding to the first road side unit, and transmit the first signal priority request packet to the first road traffic signal control machine; or
when the first receiver identifier is an identifier of the first road traffic signal control machine, transmitting the first signal priority request packet to the first road traffic signal control machine.

7. The method according to claim 1, wherein each signal priority response comprises at least one of the entrance information, priority response information, priority response type information, and priority duration information at the first intersection.

8. The method according to claim 1, wherein the first signal priority response packet further comprises an object identifier of the first signal priority response packet; and
the object identifier is configured to indicate that the first signal priority response packet is configured to describe a response of the first road traffic signal control machine to the first signal priority request packet.

9. The method according to claim 1, wherein the first signal priority response packet is based on the data sheet exchange manner of the information frame encapsulation, and the first signal priority response packet comprises the frame start, a second data sheet, a second check code, and the frame end;
the second data sheet comprises at least one of a second link code, a second transmitter identifier, a second receiver identifier, a second timestamp, second survival time, a second protocol version, operation type information of a signal priority response, the object identifier of the first signal priority response packet, a second signature tag, second reserved information, second message content, and a second signature certificate; and
the second message content comprises the N signal priority responses.

10. The method according to claim 1, wherein the first signal priority request packet further comprises the operation type information of the signal priority request.

11. The method according to claim 1, wherein the first signal priority request packet further comprises information about a request packet length and/or signal priority request quantity information of the first signal priority request packet.

12. The method according to claim 1, wherein the first signal priority response packet further comprises the operation type information of the signal priority response.

13. The method according to claim 1, wherein the first signal priority response packet further comprises information about a response message length and/or signal priority response quantity information of the first signal priority response packet.

14. The method according to claim 1, wherein the method further comprises:
receiving a signal priority request transmitted by at least one vehicle;
wherein generating the first signal priority request packet comprises:
determining the first signal priority request packet based on the signal priority request transmitted by the at least one vehicle.

15. A traffic control apparatus, deployed on a first road side unit of a first intersection, the apparatus comprising:
a memory storing a plurality of instructions; and
a processor configured to execute the plurality of instructions, and upon execution of the plurality of instructions, is configured to:
generate a first signal priority request packet, the first signal priority request packet comprising N signal priority requests, N being a positive integer greater than or equal to 1, and when N is greater than 1, the N signal priority requests configured to indicate signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection;
transmit the first signal priority request packet; and
receive a first signal priority response packet returned for the first signal priority request packet, the first signal priority response packet comprising N signal priority responses respectively for the N signal priority requests, and the N signal priority responses comprising information configured to indicate a first road traffic signal control machine of the first intersection to control a traffic management and control device of the first intersection.

16. The apparatus according to claim 15, wherein each signal priority request comprises entrance information and request priority manner information of the first intersection.

17. The apparatus according to claim 15, wherein each signal priority request further comprises at least one of request priority level information, request priority duration information, vehicle type information, vehicle location information, information about a distance between a vehicle and the first intersection, information about estimated arrival time at which a vehicle arrives at the first intersection, and information about a quantity of passengers on a vehicle.

18. The apparatus according to claim 15, wherein the first signal priority request packet further comprises an object identifier of the first signal priority request packet; and
the object identifier is configured to indicate that the first signal priority request packet is configured to describe the signal priority request reported by a vehicle.

19. The apparatus according to claim 15, wherein the first signal priority request packet is based on a data sheet exchange manner of information frame encapsulation, and the first signal priority request packet comprises a frame start, a first data sheet, a first check code, and a frame end;
the first data sheet comprises at least one of a first link code, a first transmitter identifier, a first receiver identifier, a first timestamp, a first survival time, a first protocol version, operation type information of a signal priority request, the object identifier of the first signal priority request packet, a first signature tag, first reserved information, first message content, and a first signature certificate; and
the first message content comprises the N signal priority requests.

20. A non-transitory computer readable storage medium storing a plurality of instructions executable by a processor, and upon execution by the processor, is configured to cause the processor to:
generate a first signal priority request packet, the first signal priority request packet comprising N signal priority requests, N being a positive integer greater than or equal to 1, and when N is greater than 1, the N signal priority requests configured to indicate signal priority requests initiated by a same type of vehicles at different entrances of the first intersection, or signal priority requests initiated by different types of vehicles at different entrances of the first intersection, or signal priority requests initiated by different types of vehicles at a same entrance of the first intersection, or signal priority requests initiated by a same type of vehicles at a same entrance of the first intersection;
transmit the first signal priority request packet; and
receive a first signal priority response packet returned for the first signal priority request packet, the first signal priority response packet comprising N signal priority responses respectively for the N signal priority requests, and the N signal priority responses comprising information configured to indicate a first road traffic signal control machine of the first intersection to control a traffic management and control device of the first intersection.
